(19) United States
(12) Patent Application Publication
(10) Pub. No.: US 2005/0119869 A1
(43) Pub. Date: Jun. 2, 2005

(54) Annotation method

(75) Inventors: Mark Swindells, London (GB); James Cuff, Cambridge (GB); Matthew Couch, London (GB)

Correspondence Address: DARBY & DARBY P.C., P. O. BOX 5257, NEW YORK, NY, 10150-5257, US

(73) Assignee: Inpharmatica Ltd, London (GB)

(21) Appl. No.: 10/498,850

(22) PCT Filed: Dec. 13, 2002
(86) PCT No.: PCT/GB02/05667

(30) Foreign Application Priority Data
Dec. 14, 2001 (GB) 0130006.0

(51) Int. Cl. G06G 7/48; G06G 7/58

(52) U.S. Cl. 703/11

(57) ABSTRACT

The invention relates to a method for annotating protein sequences consistently, using disparate secondary database protein family information. In the method, information relating to the family to which a protein belongs is derived from two or more secondary databases (2DBs), each 2DB being generated by a different modelling approach and wherein at least one 2DB provides no single alignment of protein sequences in each family. The method involves the steps of extracting protein family information from said at least two 2DBs; and incorporating this information into a single modelling infrastructure.

The invention relates to a method for annotating protein sequences consistently, using disparate secondary database protein family information.

There are a large and growing number of databases in the public domain which group known proteins into families of proteins that are judged to be evolutionarily related on the basis of shared characteristics. These secondary databases (2DBs) derive protein sequence and structure data from primary databases such as SWISSPROT (http://ca.expasy.org/sprot) TrEMBL (http://www.ebi.ac.uk/) and the PDB (http://www.rcsb.org/pdb). Many secondary database compilers make available an associated search program for assigning family membership to novel proteins that are not in the public domain.

Some 2DBs such as PFAM (http://www.sanger.ac.uk), PROSITE (http://ca.expasy.org/prosite/) and SCOP (http://scop.mrc-lmb.cam.ac.uk/scop) aim to be comprehensive, spanning as much as possible of the universe of known protein sequences, or known protein structures in the case of SCOP. Others, such as SMART (http://www.smart.heidelberg.de) focus more narrowly on particular classes of protein, and are smaller.

The compilers of the various 2DBs have arrived at quite different notions of what characteristics are best for defining families. Characteristics that have been used include the presence of a particular sequence motif, a statistically significant match to a more general pattern of residue conservation, or a common three-dimensional fold. Consistent within each 2DB, the approaches differ between 2DBs; offering alternative and often complementary perspectives on relatedness.

Given a novel or unannotated sequence, information indicating membership of a secondary database protein family can be extremely valuable, providing a strong suggestion as to its likely function and/or structure. However, due to the different approaches adopted, it is important to interrogate many 2DBs for this information, to obtain confirmatory evidence where possible, and to avoid overlooking available information simply because of idiosyncracies in the way in which a particular 2DB has modelled a protein family.

Incorporating evidence derived from different 2DBs is not straightforward. Regular expression searches, associated with the PROSITE regular expression families database, have no associated statistics for assessing the significance of a regular expression match. The SCOP database is compiled in an entirely non-algorithmic way (no search program). Where search programs are provided, there is often a degree of subjectivity in how search parameters are specified, having been fine-tuned by the compilers in a family-specific way. In general, differences in how protein families are modelled between 2DBs and variation in search parameters among families within a single 2DB makes it extremely difficult to assess the relative significance of matches across different 2DBs.

A second difficulty is one of implementation. Integration of many different 2DB-specific search programs into a single system is a complex and error-prone task, carrying an undesirable level of dependency on the providers of these programs.

There is thus a need for an effective method of bringing the various modelling approaches among different 2DBs within a single modelling infrastructure, one that allows evidence of matches to different 2DB families to be combined in a consistent way, and one that can be implemented in a robust manner.

### SUMMARY OF THE INVENTION

The present invention provides a method for combining information relating to the family to which a protein belongs that is derived from two or more secondary databases (2DBs), each 2DB being generated by a different modelling approach and wherein at least one 2DB provides no single alignment of protein sequences in each family, said method comprising the steps of:
a) extracting protein family information from the secondary databases;
b) incorporating said information into a single modelling infrastructure.

The single modelling infrastructure is preferably a set of representative position-specific score matrices (PSSMs), also termed profiles. The method should generate at least one PSSM for each family in each of a set of 2DBs.

For proteins that are not assigned to any particular family in a 2DB, or are missing altogether from a particular 2DB (for example, novel sequences), annotation of such sequences into specific protein families can be performed within this modelling infrastructure using any one of a number of existing profile/sequence comparison programs, an example of which is IMPALA (http://www.ncbi.nlm.nih.gov/BLAST).

Profiles have been widely used to parametrise patterns of residue conservation in either a multiple alignment of sequences or in a set of pairwise alignments of sequences to a template.

In the case of a multiple alignment of N sequences and L columns, a profile can be constructed as a matrix of 20 rows (one row for each amino acid residue type) and L columns. For a given alignment column and residue type, the corresponding matrix entry is the logarithm of an observed frequency for that residue type in the corresponding alignment column, divided by a background frequency for that residue type.

In the case of a set of pairwise alignments of N sequences to a template, the profile is defined similarly, but with the positions of the template replacing columns of the alignment. In the most general case of local pairwise alignments, there is the possibility that the local alignments will not extend over the entirety of the template, so that the set of sequences aligned at different positions of the template may vary along the template.

A robust method for calculating a profile from a set of pairwise alignments to a template was introduced as part of the Position Specific Iterated Basic Local Alignment Search Tool (PSI-BLAST) (Nucleic Acids Res 1997 Sep. 1; 25(17): 2289-3402. This method will be referred to herein as the PSI-BLAST method. It is well established. A major innovation of the PSI-BLAST method was the inclusion of a procedure for adjusting profile scores appropriately in those situations where local alignments to the template do not extend over the entirety of the template.

Several implementations of the PSI-BLAST method, applied to particular, restricted subset of 2DBs that provide appropriate alignments, have been made publicly available. For example, the NCBI provide a Conserved Domain Database (CDD) Nucleic Acids Res. 2002 Vol 30 No.1 281-283) that includes profiles calculated from alignments that are provided by PFAM and SMART. Both PFAM and SMART provide a single alignment of protein sequences considered to belong to each protein family. The CDD thus integrates data from more than one secondary database, presenting the results in a single PSSM-based modelling infrastructure.

However the outstanding challenge, met by the method of the present invention, is to produce profiles from information presented in different 2DBs, irrespective of whether any alignment information is given and/or the type of alignment information given, thereby capturing the wider diversity of information and approaches that exist currently within publicly available 2DBs.

The key novelty of the present method is to bring information from two or more 2DBs within a single modelling infrastructure, where the information from at least one of the 2DBs provides no single alignment of protein sequences in each family, that could be used directly for calculating a representative profile. Specifically, a method that combines profiles calculated from alignments provided by the PFAM, SMART and/or LOAD 2DBs only, and that does not incorporate information from any other 2DB, is disclaimed.

In one aspect of the invention, a 2DB that is suitable for analysis is one which contains information that identifies member sequences and/or regions within member sequences that contain a sequence motif or pattern of residues, but no alignment.

This aspect of the invention provides a method comprising the steps of:
a) excising a region that contains a characteristic sequence motif of a protein family from member sequences in a 2DB;
b) selecting a region from a member sequence as a template;
c) aligning the regions from other member sequences against the template using a pairwise local alignment algorithm;
d) generating a representative profile for the protein family.

In step (a), for each family in the 2DB, a region that contains the stated motif or pattern that is associated with a particular family is excised from each member sequence. In step (b) of the algorithm, one fragment from the set of fragments thus generated is chosen as the template sequence. The choice of which fragment to use as template will be context-specific, however the principle will be to choose a fragment that is typical of the family as a whole. For example, an unusually short fragment would be untypical. The remaining fragments are then aligned to this template in step (c) using a pairwise local alignment algorithm, such as, for example, the Smith-Waterman algorithm (Smith and Waterman, (1981) J Mol Biol, 147: 195-197). In step (d) the set of pairwise alignments generated in this way are used to produce a representative profile, for example using the PSI-BLAST method.

As an example application, consider the subset of the PROSITE database in which protein families are modelled using regular expression patterns. No alignment is provided for these families. Rather, the database file distributed by PROSITE contains, for each family, an entry which includes a) the regular expression pattern associated with the family, and b) a list of member sequence identifiers, corresponding to sequences in the SWISSPROT database. Further, each identifier in the list of member sequences carries a qualifier, which indicates whether or not the sequence was judged by the compilers of PROSITE to be a “true-positive” member of the family.

The algorithm preferably used herein for PROSITE regular expression families is to construct an alignment based solely on those member sequences, extracted from the SWISSPROT database, that are indicated as “true-positive” in the PROSITE entry. For each such sequence, a regular expression search is made to locate the start and end residues of the region (or regions) matching the regular expression. Each region, together with a number of flanking residues positioned before and after the regular expression is excised to produce a sequence fragment. Around 15 flanking residues can assist in the alignment of the often short fragments generated for PROSITE families based on regular expressions, but a smaller number could be appropriate in other 2DB contexts if match regions are longer. Preferably, around 15 flanking residues are taken (or as many as possible up to 15 if the match region is within 15 residues of the first or last residue of the sequence). The first fragment from the first-listed member sequence identifier in the PROSITE entry is then chosen as a template, and the remainder of the fragments are aligned to this, preferably using the BLASTP local gapped alignment algorithm (http://www.ncbi.nlm.nih.gov).

In this aspect of the invention, step a) of the method preferably comprises the steps of:
i) identifying the start and end residues of a region of a member sequence that matches the regular expression that is characteristic of a protein family;
ii) excising said region, together with a limited number of flanking residues that are positioned before and after the regular expression, to produce a sequence fragment;
   and in step b), a fragment from a member sequence identifier in the PROSITE entry is chosen as a template.

This method produces a set of pairwise local alignments to the template sequence, appropriate for calculating a PSSM-style representative profile. The algorithm is applicable to any 2DB grouping sequences on the basis of contained sequence motifs or residue patterns.

In a further aspect of the invention, a 2DB that is suitable for analysis is one that provides a Hidden Markov Model or similar position-dependent parameterisation of residue usage, but no alignment.

Hidden Markov Models (HMMs) encode patterns of position-dependent residue usage and position-dependent gapping behaviour for a given protein or protein domain family. For example, HMMs are provided with the PFAM database (http://www.sanger.ac.uk). Closely related Generalised Profiles (http://www.isrec.isb-sib.ch/profile/profile.html) are provided by PROSITE.

A profile hidden Markov model defines a multiple alignment by aligning each individual sequence to a single model. The model contains a number of “match” states that represent consensus positions of the domain. A “consensus sequence” of the domain would (in general) align entirely to match states. Deletions relative to the consensus pass through a “delete state” instead of a match state; insertions relative to the consensus pass through an “insert state” between two match states.

This aspect of the invention provides a method comprising the steps of:
a) designating the sequence of match states for a protein family as a template sequence;
b) aligning member sequences to the model using appropriate HMM/sequence or Generalised Profile/sequence comparison software;
c) treating the alignments generated in b) as pairwise alignments between the designated template and member sequences;
d) using the set of alignments generated in step c) to calculate a representative profile for the protein family.

The algorithm preferably used herein is to use alignment software, such as that provided by the 2DB, to generate alignments of the HMM or Generalised Profile with member sequences of the protein family. The sequence of match states is taken as a template sequence. Treating alignments as pairwise alignments of member sequences with the template, the set of alignments is used to calculate a representative profile.

The template defined in this way is not a real sequence, rather a consensus sequence that is associated with the HMM or Generalised Profile. A variant on the algorithm therefore is to use a particular member sequence for defining the template, rather than the sequence of match states (see below).

As an example application, consider the subset of the PROSITE database in which protein families are modelled using PROSITE Generalised Profiles. No alignment is provided for these families. Rather, the database file distributed by PROSITE contains, for each profile family, an entry which includes a) a PROSITE Generalised Profile, and b) a list of a member sequence identifiers, corresponding to sequences in the SWISSPROT database. Further, each identifier in the list of member sequences carries a qualifier, which indicates whether or not the sequence was judged by the compilers of PROSITE to be a “true-positive” member of the family.

The algorithm is to construct an alignment based solely on those member sequences, extracted from the SWISSPROT database, that are indicated as “true-positive” in the PROSITE entry. For each such sequence, a Generalised Profile search and alignment program, such as that provided by the 2DB (http://www.isrec.isb-sib.ch/software/) may be used to compare the corresponding Generalised Profile with the sequence, generating an alignment in which residues of the sequence are aligned with the sequence of profile match states. These alignments do not necessarily extend over the entirety of the sequence of profile match states, and are thus local in nature.

Taking the sequence of profile match states as template, the set of pairwise alignments so generated are used for calculating the PSSM-style representative profile.

A variant on this algorithm is to define a template using a real member sequence of the family, rather than the sequence of profile match states. In this case, the template should be chosen as the aligned region of that member sequence that receives the highest alignment score. Every other alignment between the sequence of profile match states and a member sequence is converted to an alignment between the template sequence and the member sequence, as follows.

First, the set of profile match states to which template residues are aligned should be identified. Similarly, in every other alignment, every aligned residue aligns with a particular profile match state. Where this state is in turn aligned with a residue of the template, the two residues (member sequence and template) are defined as aligned. Otherwise the template sequence is gapped at this point, and the member sequence residue appears as an insertion.

This results in a set of pairwise local alignments to the template sequence, appropriate for calculating the PSSM-style representative profile. The algorithm is applicable to any 2DB providing an HMM or similar position-based parametrization of residue usage.

In a further aspect of the invention, a 2DB that is suitable for analysis is one that provides sets of two or more partial alignment blocks for each family rather than a single alignment.

For 2DBs such as these, the 2DB compilers have attempted to capture patterns of residue usage within two or more conserved regions that are common to the set of member sequences. While providing alignments for these regions independently, there is deliberately no alignment information given for the less-conserved sections connecting the aligned regions. Thus, while alignment information is given, there is no single alignment that is appropriate for building a profile that represents the union of conserved regions.

The PRINTS database (http://www.bioinf.man.ac.uk/dbbrowser/PRINTS) follows this approach. Each aligned block represents a conserved region or “motif”. A set of aligned blocks is called a “fingerprint”. While profiles derived for each aligned block are typically quite short, and thus statistically insensitive, individually, for searching a sequence database, the approach can generate a high sensitivity by combining evidence for different motifs, assigning a significant overall match when matches are detected independently to all motifs of a fingerprint.

This aspect of the invention provides a method comprising the steps of:
a) generating a profile from each alignment block independently;
b) ordering the individual profiles generated in step a), and inserting between the profiles a number of columns of zero log odds-ratios to reflect the spacing of the aligned regions, thereby generating a representative profile for a protein family.

The algorithm preferably used in this aspect of the invention is to apply an alignment method such as the PSI-BLAST method to each alignment block independently, then to combine the individual profiles thus generated in the correct order, inserting between them a number of columns of zero log odds-ratios to reflect an appropriate spacing of the aligned regions.

When used with standard “profile to sequence” comparison algorithms such as IMPALA, the profiles constructed in this way a) allow identification of sequences with regions matching individual alignment blocks, b) allow alignments to span the connecting regions without penalty, and c) are such that the alignment score for the full alignment becomes the sum of alignment scores over the individual blocks, thereby combining evidence over the union of aligned blocks.

PRINTS provide a database file which contains, for each family, an entry which includes a) a list of member sequence identifiers, and b) a set of alignment blocks. There is one (ungapped) alignment block per motif, consisting of those member sequence segments matching the corresponding conserved. For each member sequence the file also provides the set of intermotif distances i.e. the numbers of residues between aligned segments, in each member sequence.

The algorithm preferably used herein constructs a profile for each alignment block independently, in each case taking as a template, the segment from the first listed sequence in the PRINTS entry. The profiles so generated are then concatenated into a single representative profile, inserting between a number of columns of zero log-odds ratios, the inserted number set equal to the number of intermotif residues stated for this first listed member sequence.

Such an algorithm is applicable to any 2DB that provides more than one alignment block for each family and provides data on the spacing between alignment blocks.

In a further aspect of the invention, a 2DB that is suitable for analysis is one that provides groupings of proteins, but where no attempt is made to identify characteristics that are shared at the sequence level among sequences for the proteins in each group.

This aspect of the invention provides a method comprising the steps of:
a) obtaining for each member sequence in the 2DB a set of pairwise alignments between the member sequence and other protein sequences using a search/alignment algorithm;
b) generating a profile from the set of pairwise alignments that is representative of a protein family for member sequences in the 2DB.

The algorithm preferably used in this case is thus to generate a profile for every 2DB sequence, irrespective of grouping, from a set of pairwise alignments with other sequences identified as having high-significance matches in an automated search over a large database of public sequences. In this way, each group in the 2DB is associated with a group of profiles, one per member protein sequence.

Once included within the profile infrastructure, family annotation can be assigned to any database sequence whenever there is a match to any one of the set of profiles that is associated with the family.

An example of a 2DB to which this algorithm is applicable is the SCOP database (http://www.mrc-lmb.cam.ac.uk/scop) which groups protein domains hierarchically based on their three-dimensional structure and expert judgement of their likely evolutionary relatedness. There is no information regarding their similarity at the sequence level, and there are no alignments given. Sequences corresponding to SCOP domains are provided in the ASTRAL database (http://astral.stanford.edu) and inherit the same grouping.

This algorithm is applicable to any 2DB, but is most usefully applied in the case of 2DBs in which the grouping is the only information given. The result is a set of one or more representative profiles for each family. Another currently available database to which the algorithm would be applicable is the CATH database (http://www.biochem.ucl.ac.uk/cath).

According to a further aspect of the invention, there is provided a database containing information relating to protein families that is derived from at least two 2DBs, wherein at least one 2DB provides no data relating to the alignment of protein sequences. Preferably, said database is generated using one or more of any of the methods that are described above. Preferably, said database incorporates information relating to protein families that is derived from at least three 2DBs, preferably at least four, five, six, seven, eight, nine, ten, eleven, twelve, thirteen, fourteen, fifteen, sixteen or more 2DBs. Examples of suitable 2DBs are given herein, and preferred examples include PFAM (http://www.sanger.ac.uk), PROSITE (http://www.expasy.ch), SCOP (http://scop.mrc-lmb.cam.ac.uk/scop), SMART (http://www.smart.heidelberg.de), PRINTS (http://wwww.bioinf.man.ac.uk/dbbrowser/PRINTS) and CATH (http://www.biochem.ucl.ac.uk/cath).

According to a further aspect of the invention, there is provided a computer apparatus adapted to perform a method according to any one of the aspects of the invention that are described above.

In a preferred embodiment of the invention, said computer apparatus may comprise a processor means incorporating a memory means adapted for storing data relating to protein sequences; means for inputting data relating to a plurality of protein sequences; and computer software means stored in said computer memory that is adapted to perform any one of the methods described above and output information relating to protein families that is derived from at least two 2DBs, wherein at least one 2DB provides no data relating to the alignment of protein sequences.

The invention also provides a computer-based system for combining information relating to the family to which a protein belongs that is derived from two or more secondary databases (2DBs), each 2DB being generated by a different modelling approach and wherein at least one 2DB provides no data relating to the alignment of protein sequences, said system incorporating one or more of the methods outlined above.

Preferably, said system incorporates at least one 2DB that assigns a member sequence to a particular protein family by identifying a sequence motif in the member sequence that is characteristic of said protein family, at least one 2DB that assigns a member sequence to a particular protein family by providing a Hidden Markov Model or other position-dependent parameterisation of residue usage, at least one 2DB that provides sets of two or more partial alignment blocks defining conserved regions for each protein family rather than a single alignment, and at least one 2DB that provides groupings of proteins, but wherein no attempt is made to identify characteristics that are shared at the sequence level among sequences for the proteins in each group.

Such a system should preferably include means for outputting information relating to protein family.

The system of this aspect of the invention may comprise a central processing unit; an input device for inputting requests; an output device; a memory; and at least one bus connecting the central processing unit, the memory, the input device and the output device. The memory should store a module that is configured so that upon request, it performs the steps listed in one or more of the methods of the invention that are described above.

In the apparatus and systems of these embodiments of the invention, data may be input by downloading the sequence data from a local site such as a memory or disk drive, or alternatively from a remote site accessed over a network such as the internet. Data may be input by keyboard, if required.

The combined information may be output in any convenient format, for example, to a printer, a word processing program, a graphics viewing program, to a screen display device, or preferably to a database. Other convenient formats will be apparent to the skilled reader.

According to a still further aspect of the invention, there is provided a computer program product for use in conjunction with a computer, said computer program comprising a computer readable storage medium and a computer program mechanism embedded therein, the computer program mechanism comprising a module that is configured so that upon receiving a request, it performs the steps listed in one or more of the methods of the invention that are described above.

A set of novel algorithms for producing said profiles now follows, with examples of their application. Those skilled in the art will appreciate that modification of detail may be made without departing from the scope of the invention.

### EXAMPLE 1

For 2DBs that assign a member sequence to a particular protein family by identifying a sequence motif in the member sequence that is characteristic of said protein family.

Generally speaking, for each family in the 2DB, a region containing the stated motif or pattern is excised from each member sequence. One fragment from the set of fragments so generated is chosen as the template sequence, the remaining fragments are aligned to it using the Smith-Waterman algorithm. The set of pairwise alignments generated in this way is then used directly in the PSI-BLAST method to produce a representative profile.

Specifically, consider that subset of the PROSITE database in which protein families are modelled using regular expression patterns. No alignment is provided for these families. Rather, the database file distributed by PROSITE contains, for each family, an entry which includes a) the regular expression pattern associated with the family, and b) a list of a member sequence identifiers, corresponding to sequences in the SWISSPROT database. Further, each identifier in the list of member sequences carries a qualifier, which indicates whether or not the sequence was judged by the compilers of PROSITE to be a “true-positive” member of the family.

The algorithm for PROSITE regular expression families is to construct an alignment based solely on those member sequences, extracted from the SWISSPROT database, that are indicated as “true-positive” in the PROSITE entry. For each such sequence, a regular expression search is made to locate the start and end residues of the region (or regions) matching the regular expression. Each region, together with 15 flanking residues before and after (or as many as possible up to 15 if the match region is within 15 residues of the first or last residue of the sequence) is excised to produce a sequence fragment. The first fragment from the first-listed member sequence identifier in the PROSITE entry is chosen as template, and the remainder are aligned to this using the BLASTP local gapped alignment algorithm (http://www.ncbi.nlm.nih.gov).

This produces a set of pairwise local alignments to the template sequence, appropriate for calculating a profile.

The algorithm is applicable to any 2DB grouping sequences on the basis of contained sequence motifs or residue patterns.

### EXAMPLE 2

An algorithm for producing a set of pairwise alignments to a template for 2DBs which provide a Hidden Markov Model or similar position-dependent parameterisation of residue usage, but no alignment.

Generally speaking, the algorithm is to use alignment software provided by the 2DB to generate alignments of the HMM or Generalised Profile with member sequences of the family. The sequence of match states is taken as a template sequence. Treating alignments as pairwise alignments of member sequences with the template, the set of alignments is used to calculate a profile.

Specifically, consider that subset of the PROSITE database in which protein families are modelled using PROSITE Generalised Profiles. No alignment is provided for these families. Rather, the database file distributed by PROSITE contains, for each profile family, an entry which includes a) a PROSITE Generalised Profile, and b) a list of a member sequence identifiers, corresponding to sequences in the SWISSPROT database. Further, each identifier in the list of member sequences carries a qualifier, which indicates whether or not the sequence was judged by the compilers of PROSITE to be a “true-positive” member of the family.

The algorithm is to construct an alignment based solely on those member sequences, extracted from the SWISSPROT database, that are indicated as “true-positive” in the PROSITE entry. For each such sequence, a Generalised Profile search and alignment program (http://www.isrec.isb-sib.ch/software/) is used to compare the corresponding Generalised Profile with the sequence, generating an alignment in which residues of the sequence are aligned with the sequence of profile match states. These alignments do not necessarily extend over the entirety of the sequence of profile match states, and are thus local in nature.

Taking the sequence of profile match states as template, the set of pairwise alignments so generated are used for calculating the PSSM-style representative profile.

A variant on the algorithm is to define a template using a real member sequence of the family, rather than the sequence of profile match states.

In this case, the template is chosen as the aligned region of that member sequence receiving the highest alignment score. Every other alignment between the sequence of profile match states and a member sequence is converted to an alignment between the template sequence and the member sequence, as follows.

First, the set of profile match states to which template residues are aligned is identified. Similarly, in every other alignment, every aligned residue aligns with a particular profile match state. Where this state is in turn aligned with a residue of the template, the two residues (member sequence and template) are defined as aligned. Otherwise the template sequence is gapped at this point, and the member sequence residue appears as an insertion.

This results in a set of pairwise local alignments to the template sequence, appropriate for calculating the PSSM-style profile. The algorithm is applicable to any 2DB providing an HMM or similar position-based parametrization of residue usage.

### EXAMPLE 3

Algorithm for 2DBs providing sets of two or more partial alignment blocks for each family rather than a single alignment.

In this instance, the 2DB compilers have attempted to capture patterns of residue usage within two or more conserved regions common to the set of member sequences. While providing alignments for these regions independently, there is deliberately no alignment information given for the less-conserved sections connecting the aligned regions. Thus, while alignment information is given, there is no single alignment appropriate for building a profile that represents the union of conserved regions.

The PRINTS database (http://www.bioinf.man.ac.uk/dbbrowser/PRINTS) follows this approach. Each aligned block represents a conserved region or “motif”. Here the set of aligned blocks is called a “fingerprint”. While profiles derived for each aligned block are typically quite short, and thus statistically insensitive, individually, for searching a sequence database, the approach can get a high sensitivity by combining evidence for different motifs, assigning a significant overall match when matches are detected independently to all motifs of a fingerprint.

The algorithm is to apply a method such as the PSI-BLAST method to each alignment block independently, then to combine the individual profiles so generated in correct order, inserting between them a number of columns of zero log odds-ratios to reflect an appropriate spacing of the aligned regions.

When used with standard profile to sequence comparison algorithms such as IMPALA, the profiles constructed in this way a) allow identification of sequences with regions matching individual alignment blocks, b) allow alignments to span the connecting regions without penalty, and c) are such that the alignment score for the full alignment becomes the sum of alignment scores over the individual blocks, thereby combining evidence over the union of aligned blocks.

PRINTS provide a database file which contains, for each family, an entry which includes a) a list of member sequence identifiers, and b) a set of alignment blocks. There is one (ungapped) alignment block per motif, consisting of those member sequence segments matching the corresponding conserved. For each member sequence the file also provides the set of intermotif distances i.e. the numbers of residues between aligned segments, in each member sequence.

The algorithm constructs a profile for each alignment block independently, in each case taking as template the segment from the first listed sequence in the PRINTS entry. The profiles so generated are then concatenated into a single profile, inserting between a number of columns of zero log-odds ratios, the inserted number set equal to the number of intermotif residues stated for the first listed sequence.

The algorithm is applicable to any 2DB providing more than one alignment block for each family and data on the spacing between alignment blocks.

### EXAMPLE 4

Algorithm for 2DBs that provide groupings of proteins, but no alignment information.

In this case the 2DB provide groupings of proteins, but there is no attempt to identify shared characteristics at the sequence level among sequences for the proteins in each group.

The algorithm in this case is to generate a profile for every 2DB sequence, irrespective of grouping, from a set of pairwise alignments with other sequences identified as having high-significance matches in an automated search over a large database of public sequences. In this way, each group in the 2DB is associated with a group of profiles, one per member protein sequence.

Once included within the profile infrastructure, family annotation can be assigned to any database sequence whenever there is a match to any one of the set of profiles associated with the family.

An example of a 2DB to which this algorithm is applicable is the SCOP database (http://www.mrc-lmb.cam.ac.uk/scop) which groups protein domains hierarchically based on three-dimensional structure and expert judgement of likely evolutionary relatedness. There is no information regarding similarity at the sequence level, there are no alignments given. Sequences corresponding to SCOP domains are provided in the ASTRAL database (http://astral.stanford.edu) and inherit the same grouping.

The algorithm is applicable to any 2DB, but is most usefully applied in the case of 2DBs in which the grouping is the only information given. The result is a set of one or more profiles for each family. Another database to which the algorithm would be currently applicable is CATH (http://www.biochem.ucl.ac.uk/cath).

1. A method for combining information relating to the family to which a protein belongs that is derived from two or more secondary databases (2DBs), each 2DB being generated by a different modeling approach and wherein at least one 2DB provides no single alignment of protein sequences in each family, said method comprising the steps of:
(a) extracting protein family information for said at least two 2DBs; and
(b) incorporating said information into a single modeling infrastructure.

2. A method according to claim 1, wherein said single modelling modeling infrastructure is a representative profile for each protein family.

3. A method according to claim 2, wherein said representative profile is a set of position specific score matrices (PSSM).

4. A method according to claim 3, wherein at least one PSSM is generated for each family in each set of 2DBs.

5. A method according to claim 1, wherein at least one 2DB assigns a member sequence to a particular protein family by identifying a sequence motif in the member sequence that is characteristic of said protein family.

6. A method according to claim 5, comprising the steps of:
(a) excising a region that contains a characteristic sequence motif of a protein family from member sequences in a 2DB;
(b) selecting a region from a member sequence as a template;
(c) aligning the regions from other member sequences against the template using a pairwise local alignment algorithm; and
(d) generating a representative profile for the protein family.

7. A method according to claim 5, wherein said 2DB is the PROSITE database (http://www.expasy.ch).

8. A method according to claim 7, wherein the method aligns member sequences that are indicated as “true-positive” in the PROSITE entry by virtue of the member sequence identifiers.

9. A method according to claim 8, wherein step (a) comprises steps of
(i) identifying the start and end residues of a region of a member sequence that matches the regular expression that is characteristic of a protein family; and
(ii) excising said region, together with a limited number of flanking residues that are positioned before and after the regular expression, to produce a sequence fragment.

10. A method according to claim 8, wherein is step (b), a fragment from the first-listed member sequence identifier in the PROSITE entry is chosen as a template.

11. A method according to claim 1, wherein at least one 2DB assigns a member sequence to a particular protein family by providing a Hidden Markov Model or other position-dependent parameterisation of residue usage.

12. A method according to claim 11, wherein said 2DB is the PFAM database (http://www.sanger.ac.uk) or a database of Generalised Profiles (http://www.isrec.isb-sib.ch/profile/profile.html) provided by PROSITE.

13. A method according to claim 12, comprising steps of:
(a) designating the sequence of match states for a protein family as a template sequence;
(b) aligning member sequences to the template sequence by pairwise alignment; and
(c) using the set of alignments generated in step (b) to calculate a representative profile for the protein family.

14. A method according to claim 13, wherein is step (a), a member sequence is used as the template.

15. A method according to claim 1, wherein at least one 2DB provides sets of two or more partial alignment blocks defining conserved regions for each protein family rather than a single alignment.

16. A method according to claim 15, wherein said 2DB is the PRINTS database (http://www.bioinf.man.ac.uk/dbbrowser/PRINTS).

17. A method according to claim 16, wherein the set of partial alignment blocks is a fingerprint.

18. A method according to claim 16, which comprises the steps of:
(a) aligning each partial alignment block in member sequences in the 2DB independently to generate a profile; and
(b) ordering the individual profiles generated in step (a), and inserting between the profiles a number of columns of zero log odds-ratios to reflect the spacing of the aligned regions to generate a representative profile.

19. A method according to claim 18, wherein is step (a), the segment of sequences from the first listed sequence is taken as the template; and in step (b), the number of columns of zero log odds-ratios inserted is set as equal to the number of intermotif residues stated for the first listed sequence.

20. A method according to claim 1, wherein at least one 2DB provides groupings of proteins, but no attempt is made to identify characteristics that are shared at the sequence level among sequences for the proteins in each group.

21. A method according to claim 20, wherein said 2DB is the SCOP database (http://www.mrc-lmb.cam.ac.uk/scop) or the CATH database (http://www.biochem.ucl.ac.uk/cath).

22. A method according to claim 20, comprising the steps of:
(a) performing a set of pairwise alignments between individual member sequences in the 2DB and member sequences contained in a database of sequences; and
(b) generating a profile from the set of pairwise alignments that is representative of a protein family for member sequences in the 2DB.

23. A database containing information relating to protein families that is derived from at least two 2DBs, wherein at least one 2DB provides no data relating to the alignment of protein sequences.

24. A database according to claim 23, which is generated using a method comprising steps of:
(a) extracting protein family information from said at least two 2DBs; and
(b) incorporating said information into a single modelling infrastructure.

25. A database according to claim 23, which incorporates information relating to protein families that is derived from at least three, four, five, six, seven, eight, nine, ten, eleven, twelve, thriteen, fourteen, fifteen, sixteen or more 2DBs.

26. A database according to claim 23, wherein said 2DBs are selected from the group consisting of PFAM (http://www.sanger.ac.uk), PROSITE (http://www.expasy.ch), SCOP (http://scop.mrc-lmb.cam.ac.uk/scop), SMART (http://www.smart.heidelberg.de), PRINTS (http://www.bioinf.man.ac.uk/dbbrowser/PRINTS) and CATH (http://www.biochem.ucl.ac.uk/cath).

27. A computer apparatus adapted to perform a method according to claim 1.

28. A computer-based system for combining information relating to the family to which a protein belongs that is derived from two or more secondary databases (2DBs), each 2DB being generated by a different modelling approach and wherein at least one 2DB provides no data relating to the alignment of protein sequences, said system incorporating a method according to claim 1.

29. A system according to claim 28, additionally including means for outputting information relating to protein family.

30. A computer program product for use in conjunction with a computer, said computer program comprising a computer readable storage medium and a computer program mechanism embedded therein, the computer program mechanism comprising a module that is configured so that upon receiving a request, it performs a method according to claim 1.
